(19) United States
(12) Patent Application Publication
(10) Pub. No.: US 2009/0242481 A1
(43) Pub. Date: Oct. 1, 2009

(54) GAS/LIQUID SEPARATOR WITH NON-SQUARE-EDGED OUTLET OPENINGS

(76) Inventor: Ewout Carel Barents, Velp (NL)

Correspondence Address: WILLIAMS, MORGAN & AMERSON, 10333 RICHMOND, SUITE 1100, HOUSTON, TX, 77042, US

(21) Appl. No.: 12/059,227

(22) Filed: Mar. 31, 2008

(51) Int. Cl. B01D 21/26

(52) U.S. Cl. 210/512.2

(57) ABSTRACT

A gas/liquid separator including a housing, at least one swirl element positioned in the housing and at least one opening formed in the housing downstream of the at least one swirl element, wherein the at least one opening comprises a non-square-edged sidewall that defines at least a portion of the at least one opening.

### BACKGROUND OF THE INVENTION

1. Field of the Invention

The present invention is generally directed to the field of gas/liquid separation devices, and, more particularly, to a gas/liquid separator with non-square-edged outlet openings.

2. Description of the Related Art

Cyclones are used on a large scale to separate gas/liquid mixtures, for instance, to dry natural gas. On extraction from the earth, natural gas can be mixed with salt water, which may cause corrosion in the pipelines through which the gas is transported.

A so-called axial cyclone generally comprises an outer wall or housing with openings formed in the housing and means for rotating the incoming stream that is comprised of liquids and gas. Typically, the means for causing rotation of the incoming stream comprises one or more so-called swirl elements. The flow of the entering mixture past or through the swirl element causes the entering mixture to rotate, whereby a heavy fraction (on the order of magnitude of 2-25% of the total flow), in which a relatively large amount of liquid is present, is flung against the inner wall of the housing of the cyclone due to centrifugal force. This fraction can be discharged through the plurality of openings that are arranged in the outer wall of the housing of the cyclone. It is also known to reintroduce a part of the discharged fraction into the entering mixture in order to further separate this fraction into liquid and gas phases. One illustrative example of such an axial flow cyclone is depicted in U.S. Pat. No. 7,163,622.

One problem associated with prior art axial flow cyclones is that there was excessive amounts of liquid re-entrainment at the openings in the outer wall of the cyclone. Such openings are formed with square-edged sidewalls. More specifically, the spinning fluid inside the cyclone housing formed a relatively steady liquid film against the inner wall of the housing due to centrifugal force. As soon as the liquid film passed one edge of an opening or slot in the housing, the trajectory of the liquid moves further outward and collides with the square edge on the opposite side of the slot or opening. This disruption causes some of the fluid to deflect or bounce off the edge of the slot or opening back into the housing. The re-introduction of this deflected stream (primarily liquid) back into the housing disturbs the steady spinning liquid film and decreases the efficiency of the cyclone as the re-entrained fluid has not been separated.

The present invention is directed to an apparatus for solving, or at least reducing the effects of, some or all of the aforementioned problems.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one illustrative embodiment,

### BRIEF DESCRIPTION OF THE DRAWINGS

The invention may be understood by reference to the following description taken in conjunction with the accompanying drawings, in which like reference numerals identify like elements, and in which:

FIG. 1 is a perspective view of one illustrative embodiment of the present subject matter;

FIGS. 2A-2B depict, respectively, aspects of outlets on prior art gas/liquid separator devices;

FIGS. 2C-2J depict various aspects of the outlets for a gas/liquid separator as described herein; and

FIG. 3 is a graph that depicts illustrative improvements that may be achieved using a gas/liquid separator with the outlets described herein.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the present subject matter are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

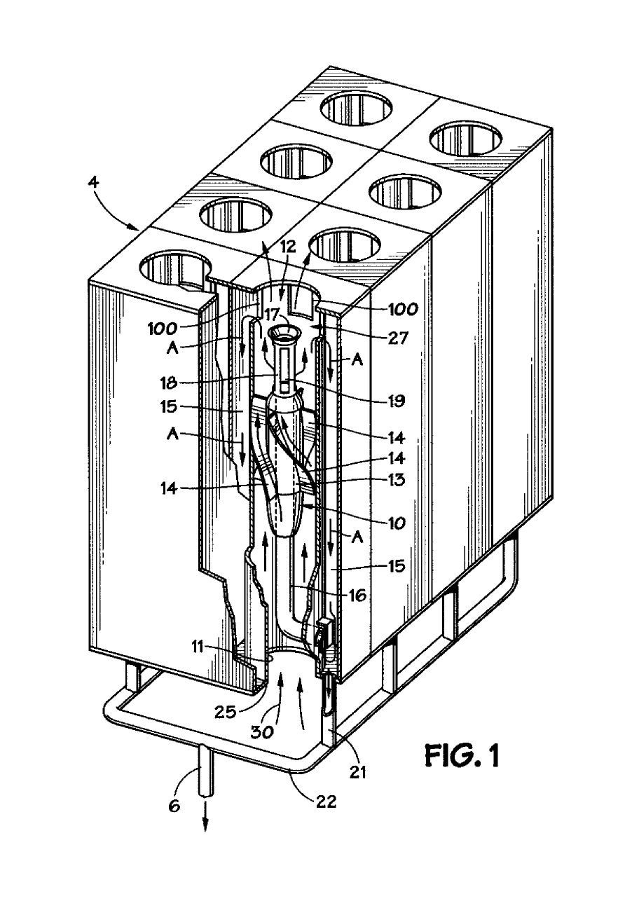

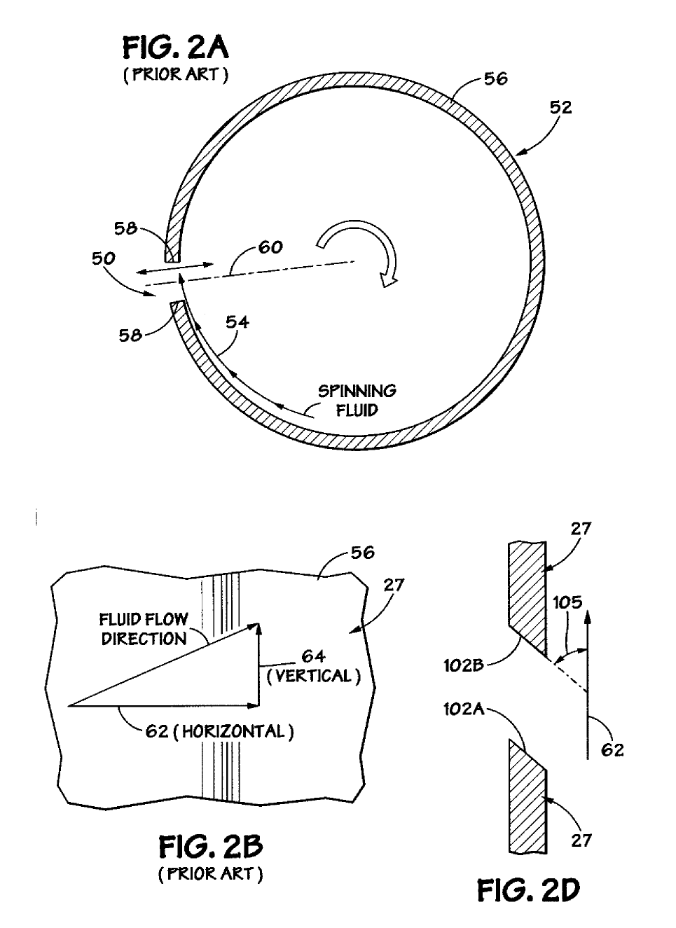

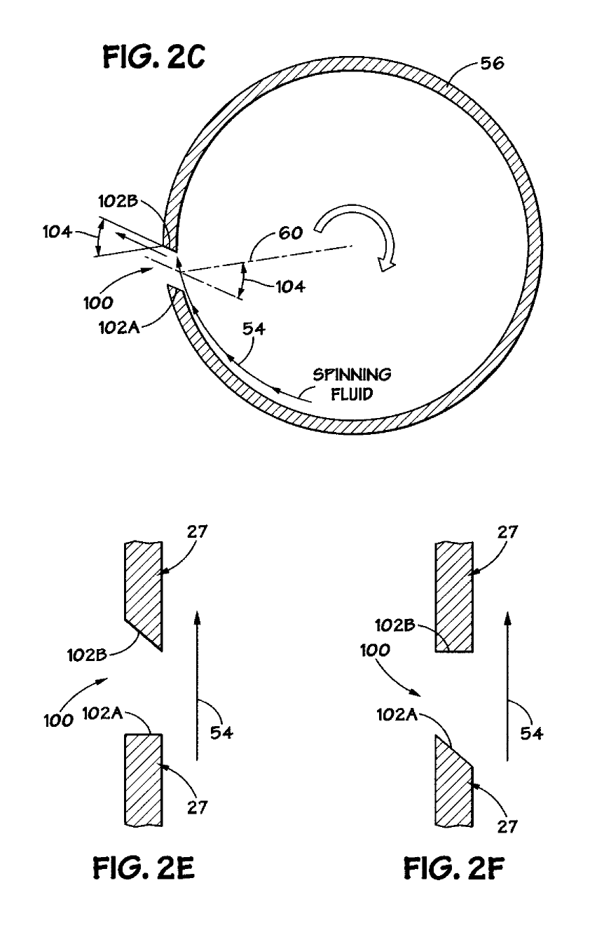

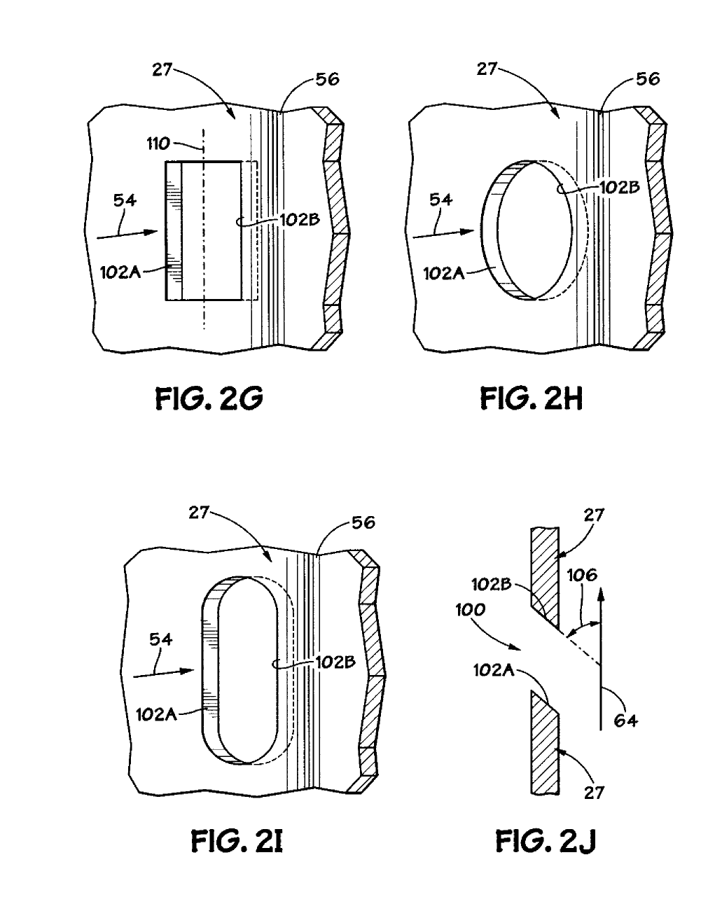

FIG. 1 depicts an illustrative liquid/gas separator employing the non-square-edged openings 100 described herein. FIG. 1 is the same as FIG. 2 from U.S. Pat. No. 7,163,622, which is hereby incorporated by reference in its entirety, with the addition of the angled or non-square-edged openings 100 described herein. Of course, as will be understood by those skilled in the art after a complete reading of the present application, the subject matter disclosed herein may be employed with liquid/gas separators having a variety of configurations. Thus, the particular embodiments disclosed herein should not be considered a limitation of the present invention.

FIG. 1 depicts an illustrative embodiment of a box 4 that contains eight cyclones 10, one of which is depicted in detail in FIG. 1. Each cyclone 10 generally comprises a housing or cylindrical wall 11 having an inlet opening 25 and an outlet opening 12 on the upper side thereof. A gas/liquid mixture 30 is introduced into the cyclone 10 via the inlet 25 and exits the cyclone 10 via the outlet 12. In the depicted embodiment, a so-called swirl element 13 is positioned approximately in the middle of the space enclosed by the housing or cylindrical wall 11. The swirl element 13 comprises a plurality of blades 14 for causing the mixture 30 to rotate. Of course, the structure of the swirl element 13 is provided by way of example only. After a complete reading of the present application, those skilled in the art will appreciate that the subject matter disclosed herein may be employed with swirl elements having a vast variety of different configurations.

As the gas/liquid mixture 30 rotates, due to the swirl element 13, a portion of the gas/liquid mixture 30 is flung outward against the inner surface 27 of the housing or cylindrical wall 11. When the primarily liquid film (not shown) reaches the openings 100, the heavier components of the film, i.e., primarily liquid, exit the housing 11 via the openings 100. The portion of stream that exits through the openings 100, as indicated by the arrows A, is recycled or transported via an interspace 15 to a recycle conduit 16. In the depicted embodiment, the recycle conduit 16 extends through swirl element 13 and is closed at the top with a substantially conical cap 17. Under conical element 17 slots 19 are recessed into an end part 18 of conduit 16 to allow the mixture recycled via conduits 16 (about 15% of the quantity of the original mixture) to exit in a divergent manner. Further connected to space 15 is a conduit 21 for draining liquid. The conduit 21 drains into a common ring drain line 22 into which the drain conduits of the other cyclones 10 also drain. A downcorner 6 is connected to the ring drain line 22. Ultimately, the collected fluid that drains out of the downcorner 6 may be collected in a vessel or it may be collected for disposal.

FIG. 2A schematically depicts the arrangement of openings or slots 50 on an illustrative prior art gas/liquid separator device 52. As shown therein, the fluid 54 rotates within the housing 56. In practice, the housing 56 will typically comprise several outlet openings 50, although only one such opening 50 is depicted in FIG. 2A for purposes of discussion. The opening 50 is formed with square edges 58, and the centerline 60 of the opening 50 is substantially perpendicular to the direction of rotation of the rotating fluid 54, when viewed from above. Stated another way, in one illustrative embodiment, the opening 50 is formed such that the square-edged sidewalls 58 of the opening 50 are positioned substantially normal (when viewed from above) to the horizontal component 62 of the flow of the rotating fluid 54, as depicted graphically in FIG. 2B. In other embodiments, the square-edged sidewalls 58 may be positioned at an angle relative to the horizontal component 62 of the fluid 54. Openings 50 with such squared edge 58 configurations tend to cause localized disturbances in the flow of the fluid 54. It is believed that such disturbances may occur when, due to centrifugal force, some of the rotating fluid 54 engages a portion of at least the downstream edge 58 and is directed back inside the housing 56.

FIG. 2C depicts a gas/liquid separator device having one or more outlets 100 configured as described herein. For purposes of clarity, only a single outlet 100 is depicted in FIG. 2C. In practice, a gas/liquid separator may have a plurality of such openings 100. The opening 100 comprises non-square-edged sidewalls 102A, 102B. The non-square-edged sidewalls 102A, 102B may extend around the entirety of the opening 100 or only portions thereof. For example, in the case of an elongated slot, only the long sides of the slot may have such non-square-edged openings while the upper and lower edges that further define the slot may be provided with square-edged sidewalls. In the depicted embodiment, the non-square-edged sidewalls 102A, 102B are angled sidewalls. In the depicted embodiment, each of these angled sidewalls 102A, 102B are formed at an angle 104 relative to a radius line 60 from the center of the housing. The magnitude of the angle 104 may vary depending upon the particular application, e.g., 10-75 degrees. Stated another way, when viewed from above, the angled sidewalls 102A, 102B are oriented on an angle 105 with respect to the horizontal component 62 of the rotating fluid flow 54, as shown in FIG. 2D. In one case, the angle 105 may be approximately the same as the angle 104. When viewed from the side, the angled sidewalls 102A, 102B may be oriented at an angle 106 with respect to the vertical component 64, as shown in FIG. 2G. In some cases, the angle 106 may be approximately the same as the angle 104 or 105.

In some embodiments, the angled sidewalls 102A, 102B need not be oriented at the same angle, although they can be if desired. In the embodiment shown in FIG. 2C, the angled sidewalls 102A, 102B may be thought of as the upstream and downstream angled sidewalls, respectively. The references to “upstream” and “downstream” refer to the location of the angled sidewalls 102A, 102B relative to the direction of rotation of the rotating fluid 54. In some applications, as shown in FIG. 2E, only the downstream sidewall, e.g., angled sidewall 102B, is provided with a non-square-edged sidewall, e.g., an angled sidewall, while the upstream sidewall is substantially square-edged. In other embodiments, as shown in FIG. 2F, only the upstream sidewall 102A may be provided with a non-square-edged sidewall, e.g., an angled sidewall.

The general configuration of the openings 100 may also vary. As shown in FIGS. 2G-2I, the opening 100 may be configured as an elongated slot, an oval opening, a circular opening, respectively, etc. Thus, the overall shape of the opening 100 should not be considered a limitation of the present invention. The openings 100 may be oriented vertically, horizontally or they may have a spiral or tilted orientation. The axis or centerline of such openings 100 may be oriented at any angle relative to the central axis of the cyclone 10. For example, the long axis 110 of the illustrative slot depicted in FIG. 2G may be substantially parallel to the axis of the cyclone 10, or the long axis 110 may be oriented at an angle relative to the axis. Such configurations are known in the art as reflected in international published application WO 03/039755, which is hereby incorporated by reference.

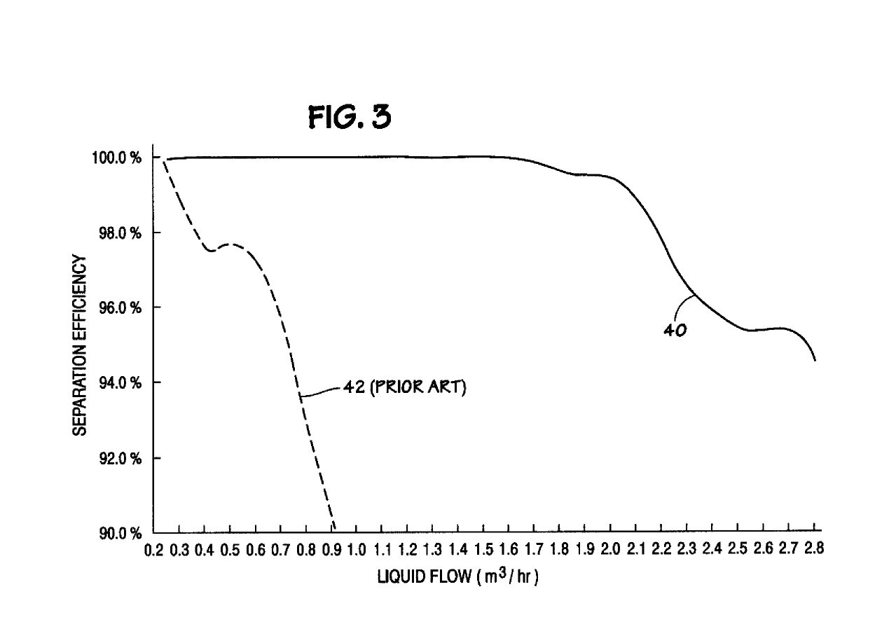

The openings 100 with at least one non-square-edged sidewall 102A, 102B provide significant improvements over the prior art openings with the substantially square-edged or right-angled sidewalls, as shown in FIG. 2A. FIG. 3 is a chart that graphically depicts the improvement in separator efficiency and increased liquid handle capacity for a gas/liquid separator employing the openings 100 described herein with the non-square-edged sidewalls (line 40) as compared to a prior art gas/liquid separator with outlets having square-edged sidewalls (line 42). The information depicted in FIG. 3 was obtained by comparing a separator with elongated slots with square-edged sidewall configurations to a separator with angled slots 102A, 102B formed at an angle 104 of approximately 30 degrees. The liquid was mixed into the gas-phase by a spray nozzle to provide a well distributed gas/liquid mixture 30. This was then sent through the cyclone 13. Both the carryover and the separated liquid were captured and measured. This was done to double check the total amount of incoming liquid, which was measured by a calibrated flow meter. The carryover was captured by a de-misting pad and measured. Therefore, the efficiencies of the cyclone with and without a non-square edge could be calculated and compared.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A gas/liquid separator, comprising:
a housing;
at least one swirl element positioned in said housing; and
at least one opening formed in said housing downstream of said at least one swirl element, wherein said at least one opening comprises a non-square-edged sidewall that defines at least a portion of the at least one opening.

2. The gas/liquid separator of claim 1, wherein said non-square-edged sidewall is on an upstream side of said at least one opening.

3. The gas/liquid separator of claim 1, wherein said non-square-edged sidewall is on a downstream side of said at least one opening.

4. The gas/liquid separator of claim 1, wherein said non-square-edged sidewall is on both an upstream side and a downstream side of said at least one opening.

5. The gas/liquid separator of claim 1, wherein said at least one opening has a configuration of an elongated slot, an oval or a circle.

6. The gas/liquid separator of claim 1, wherein said non-square-edged sidewall is an angled sidewall.

7. The gas/liquid separator of claim 6, wherein said angled sidewall is formed at an angle ranging from 10-75 degrees relative to a radial line extending from a center of said housing to said at least one opening.

8. A gas/liquid separator, comprising:
a housing;
at least one swirl element positioned in said housing; and
a plurality of openings formed in said housing downstream of said at least one swirl element, wherein each of said openings comprises non-square-edged sidewalls on both an upstream side and a downstream side of said opening, said non-square-edged sidewalls defining at least a portion of said opening.

9. The gas/liquid separator of claim 8, wherein said at least one opening has a configuration of an elongated slot, an oval or a circle.

10. The gas/liquid separator of claim 8, wherein each of said non-square-edged sidewalls is an angled sidewall.

11. The gas/liquid separator of claim 10, wherein said angled sidewall is formed at an angle ranging from 10-75 degrees relative to a radial line extending from a center of said housing to said at least one opening.

12. A gas/liquid separator, comprising:
a housing;
at least one swirl element positioned in said housing; and
at least one opening formed in said housing downstream of said at least one swirl element, wherein said at least one opening comprises a non-square-edged sidewall on at least one of an upstream side and a downstream side of said at least one opening.

13. The gas/liquid separator of claim 12, wherein said at least one opening has a configuration of an elongated slot, an oval or a circle.

14. The gas/liquid separator of claim 12, wherein said non-square-edged sidewall is an angled sidewall.

15. The gas/liquid separator of claim 14, wherein said angled sidewall is formed at an angle ranging from 10-75 degrees relative to a radial line extending from a center of said housing to said at least one opening.
